(19) United States
(12) Patent Application Publication
(10) Pub. No.: US 2018/0114141 A1
(43) Pub. Date: Apr. 26, 2018

(54) PLANNING METHOD FOR LEARNING AND PLANNING SYSTEM FOR LEARNING WITH AUTOMATIC MECHANISM OF GENERATING PERSONALIZED LEARNING PATH

(71) Applicant: INSTITUTE FOR INFORMATION INDUSTRY, Taipei (TW)

(72) Inventors: Hsiao-Chien TSENG, Yilan County (TW); Chieh-Feng CHIANG, Taoyuan City (TW); Jun-Ming SU, Hsinchu County (TW)

(21) Appl. No.: 15/347,801

(22) Filed: Nov. 10, 2016

(30) Foreign Application Priority Data
Oct. 25, 2016 (TW) 105134445

(51) Int. Cl. G06N 99/00; G06N 7/02

(52) U.S. Cl. CPC G06N 99/005; G06N 7/02

(57) ABSTRACT

The present disclosure provides a planning method for learning applied to a planning system for learning, and the planning system for learning includes a storage, a monitor and a processor. The planning method for learning includes the following steps: recording learning information of a plurality of subjects and storing the learning information in the storage via the monitor; calculating weighting parameters of the subjects according to the learning information and calculating weighting scores of the subjects according to the weighting parameters via the processor; and performing a fuzzy process to the weighting scores via the processor to transform the weighting scores into score levels of the subjects, so as to establish a learning sequence of the subjects to establish a learning plan.

### RELATED APPLICATIONS

This application claims priority to Taiwan Application Serial Number 105134445, filed Oct. 25, 2016, which is herein incorporated by reference.

### BACKGROUND

### Field of Invention

The present disclosure relates to a data processing method and a data processing system. More particularly, the present disclosure relates to a planning method for learning and a planning system for learning.

### Description of Related Art

With the rapid development of automatic technology, automatic planning systems are widely used in human life and play an increasingly important role. For example, a planning system for learning can automatically provide planning services for users' learning. However, the current planning system for learning mainly classifies different users into various categories according to user's personally information correspondingly, and then provides the planning services for learning according to the category that the user corresponds to. In other words, the current planning system for learning does not tailor the adaptive learning planning services for an individual user. Thus, the quality of user experience of planning system for learning is possibly reduced. Although through analyzing the personal information of individual user to provide planning services for learning can effectively improve the quality of user experience of the planning system for learning, this method possibly significantly increase the operation complexity of the planning system for learning.

For the forgoing reasons, there is a need to design a planning method for learning and a planning system for learning that can effectively improve the quality of user experience of the planning system for learning without increasing the operation complexity of the planning system for learning.

### SUMMARY

A planning method for learning applied to a planning system for learning is provided, and the planning system for learning comprises a storage, a monitor, and a processor. The planning method for learning comprises the following steps: recording learning information of a plurality of subjects and storing the learning information in the storage via the monitor; calculating weighting parameters of the subjects according to the learning information and calculating weighting scores of the subjects according to the weighting parameters via the processor; and performing a fuzzy process to the weighing scores via the processor to transform the weighting scores into score levels of the subjects so as to establish a learning sequence of the subjects to establish a learning plan.

The disclosure provides a planning system for learning. The planning system for learning comprises a storage, a monitor, and a processor. The monitor is configured to record learning information of a plurality of subjects and store the learning information in the storage. The processor is configured to calculate weighting parameters of the subjects according to the learning information and calculate weighting scores of the subjects according to the weighting parameters. The processor performs a fuzzy process to the weighing scores to transform the weighting scores into score levels of the subjects so as to establish a learning sequence of the subjects to establish a learning plan.

In summary, the technical solution of the present disclosure has obvious advantages and beneficial effects as compared with the prior art. Through the above technical solution, considerable advances in technology and extensive industrial applicability can be achieved. The planning method for learning and planning system for learning according to the present disclosure calculate the weighing parameters and the weighting scores according to the learning information, and perform a fuzzy process to transform the weighting scores into the score levels of the subjects so as to establish the learning sequence of the subjects to establish the learning plan via the processor. For example, the learning information may be the user's operation information corresponding to the teaching materials for the subjects or the user's test information of the subjects. Therefore, the planning method for learning and planning system for learning according to the present disclosure can provide the adaptive learning planning services for different users according to the learning information so as to improve the quality of user experience of the planning system for learning and reduce the operation complexity of the planning system for learning through the fuzzy process.

It is to be understood that both the foregoing general description and the following detailed description are by examples, and are intended to provide further explanation of the disclosure as claimed.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure. In the drawings,

FIG. 1A depicts a block schematic diagram of a planning system for learning according to one embodiment of the disclosure;

FIG. 1B and FIG. 1C depict schematic diagrams of a learning sequence of subjects according to embodiments of the disclosure; and

FIG. 2 depicts a flowchart of a planning method for leaning according to one embodiment of the disclosure.

### DESCRIPTION OF THE EMBODIMENTS

Reference will now be made in detail to embodiments of the present disclosure, examples of which are described herein and illustrated in the accompanying drawings. While the disclosure will be described in conjunction with embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. It is noted that, in accordance with the standard practice in the industry, the drawings are only used for understanding and are not drawn to scale. Hence, the drawings are not meant to limit the actual embodiments of the present disclosure. In fact, the dimensions of the various features may be arbitrarily increased or reduced for clarity of discussion. Wherever possible, the same reference numbers are used in the drawings and the description to refer to the same or like parts for better understanding.

The terms used in this specification and claims, unless otherwise stated, generally have their ordinary meanings in the art, within the context of the disclosure, and in the specific context where each term is used. Certain terms that are used to describe the disclosure are discussed below, or elsewhere in the specification, to provide additional guidance to the practitioner skilled in the art regarding the description of the disclosure.

In the following description and in the claims, the terms “comprising”, “including”, “having”, “containing”, “involving” and the like are used in an open-ended fashion, and thus should be interpreted to mean “include, but not limited to.” As used herein, the term “and/or” includes any and all combinations of one or more of the associated listed items.

In this document, the term “coupled” may also be termed “electrically coupled,” and the term “connected” may be termed “electrically connected.” “Connected” or “coupled” may also be used to indicate that two or more elements cooperate or interact with each other.

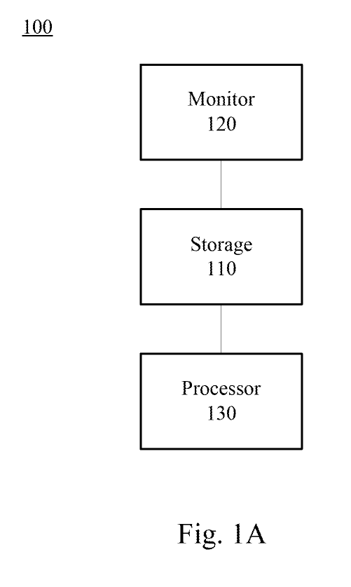

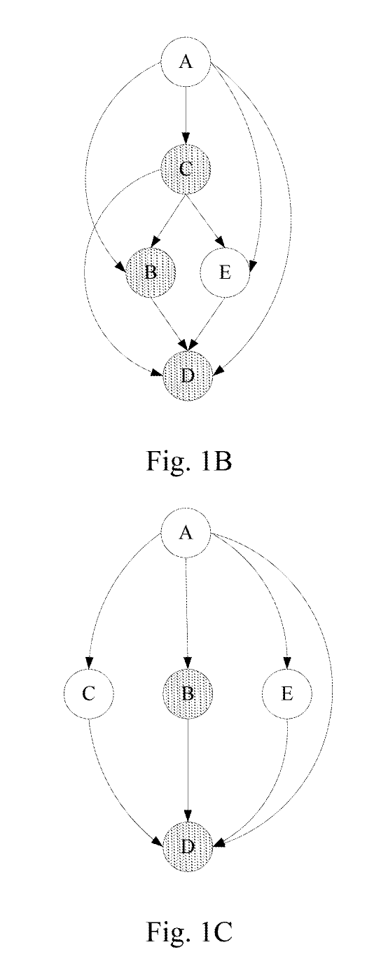

FIG. 1A depicts a block schematic diagram of a planning system for learning 100 according to one embodiment of the disclosure. As shown in FIG. 1A, the planning system for learning 100 comprises a storage 110, a monitor 120, and a processor 130. The monitor 120 is electrically connected to the storage 110, and the processor 130 is electrically connected to the storage 110.

The storage 110 may be implemented by using a computer hard drive, a server, or a recording medium that those of ordinary skill in the art can easily think of and has the same function. The monitor 120 may be any actual element that can transform a course of action of a user (includes learning information of a plurality of subjects) into recording data. The processor 130 may be implemented by using a central processor, a microcontroller, or a similar element.

The monitor 120 is configured to record the learning information of the plurality of subjects, and store the learning information in the storage 110. The processor 130 is configured to calculate weighting parameters of the subjects according to the learning information, and calculate weighting scores of the subjects according to the weighting parameters. The processor 130 performs a fuzzy process to the weighting scores so as to transform the weighting scores into score levels of the subjects. The learning sequence of the subjects is thus established to establish a learning plan. In one embodiment, the learning information may be represented as user's test information of the subjects correspondingly. For example, the test information may be represented as original scores of the subjects. The processor 130 can multiply the weighting parameters and the original scores of the subjects to obtain the weighting scores. After the processor 130 performs the fuzzy process to the weighting scores, each of the weighting scores can be transformed into a score level correspondingly. In other words, the planning system for learning 100 can reduce operation complexity through the fuzzy process so as to accelerate the operation of the planning system for learning 100.

In one embodiment, the learning information of the subjects comprises the number of times of learning and learning time. The processor 130 is configured to calculate the weighting parameters of the subjects according to the number of times of learning and the learning time. In another embodiment, the learning information may be represented as user's operation information corresponding to teaching materials for the subjects. For example, operation information of the teaching materials may be represented as the number of times that the teaching materials are operated or operating time of the teaching materials, and the processor 130 can calculate the weighting parameters of the subjects according to the number of times that the teaching materials are operated and the operating time of the teaching materials. In the present embodiment, the number of times that the teaching materials are operated is positively correlated with familiarity of the user with the teaching materials, and the operating time of the teaching materials is negatively correlated with the familiarity of the user with the teaching materials. Hence, the processor 130 can increase the weighting parameters according to the number of times that the teaching materials are operated and conversion functions correspondingly, or decrease the weighting parameters according to the operating time of the teaching materials and conversion functions correspondingly. It should be understood that the above embodiment only serves as an example for illustrating how the learning information is presented and how the weighting parameters are calculated, and the present disclosure is not limited in this regard.

In one embodiment, when the weighting score corresponding to a first subject of the subjects is lower than or equal to a first threshold value, the processor 130 transforms the weighting score corresponding to the first subject into a first score level; when the weighting score corresponding to a second subject of the subjects is higher than the first threshold value, the processor 130 transforms the weighting score corresponding to the second subject into a second score level. For example, the processor 130 can perform the fuzzy process to the weighting scores to which the different subjects correspond (in the present embodiment, transform them into the first score level or the second score level) through a predetermined threshold value (in the present embodiment, the first threshold value) so as to reduce the operation complexity of the planning system of learning 100. It should be understood that the above embodiment only serves as an example for illustrating the feasible implementation method of the fuzzy process, and the present disclosure is not limited in this regard. For example, the processor 130 can transform the weighting score of each of the subjects into the score level correspondingly (such as the first score level, the second score level, a third score level, and so forth) according to a plurality of predetermined threshold values (such as the first threshold value, a second threshold value, and so forth).

In another embodiment, after the processor 130 transforms the weighting score corresponding to the first subject into the first score level, and transforms the weighting score corresponding to the second subject into the second score level, the processor 130 establishes a forward learning sequence from the second subject to the first subject. A description is provided with reference to FIG. 1B and FIG. 1C. FIG. 1B and FIG. 1C depict schematic diagrams of a learning sequence of subjects according to embodiments of the disclosure. When a score level corresponding to a subject A is higher than a score level corresponding to a subject C, the processor 130 can establish a forward learning sequence from the subject A to the subject C. Hence, the planning system for learning 100 can determine that a learning order of the subject A should be superior to that of the subject C for the user, and perform the learning plan for the user. In still another embodiment, when the score level of the subject is higher than a threshold level, the processor 130 can determine that the user has the capability to handle this subject so that the planning system for leaning 100 can suggest the user study some other subject(s) first.

In one embodiment, the monitor 120 is configured to immediately update the learning information of the subjects, and store the updated learning information in the storage 110. In another embodiment, the processor 130 re-establishes the learning plan according to the updated learning information and the updated learning sequence. A description is provided with reference to FIG. 1B and FIG. 1 C. For example, white circles represent subjects that the user has the capability to handle, grey dot circles represent subjects that the user does not have the capability to handle. As shown in FIG. 1B, since at this time the subject A and a subject E are the subjects that the user has the capability to handle, the planning system for learning 100 suggests the user study according to a sequence: the subject C, a subject B, and then a subject D. As shown in FIG. 1C, after the planning system for learning 100 updates the learning information via the monitor 120 and determines that the user has the capability to handle the subject C according to the updated learning information, the planning system for learning 100 can re-establish the learning plan to suggest the user study according a sequence: the subject B, and then the subject D. It should be understood that the above embodiments only serve as examples for illustrating the feasible implementation method of re-establishing the learning, and the present disclosure is not limited in this regard.

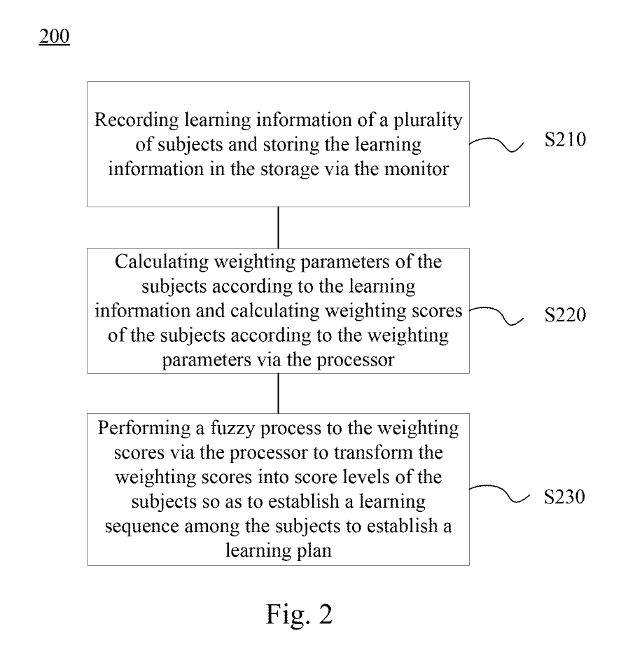

FIG. 2 depicts a flowchart of a planning method for leaning 200 according to one embodiment of the disclosure. In one embodiment, the planning method for leaning 200 can be implemented in the planning system for learning 100, but the present disclosure is not limited in this regard. In order to facilitate the understanding of the planning method for learning 200, the planning system for learning 100 serves as an example for implementing the planning method for learning 200 as follows. As shown in FIG. 2, the planning method for learning 200 comprises the following steps:
S210: record learning information of a plurality of subjects and store the learning information in the storage 110 via the monitor 120;
S220: calculate weighting parameters of the subjects according to the learning information and calculate weighting scores of the subjects according to the weighting parameters via the processor 130; and
S230: perform a fuzzy process to the weighting scores via the processor 130 to transform the weighting scores into score levels of the subjects so as to establish a learning sequence of the subjects to establish a learning plan.

In one embodiment, the learning information may be represented as user's test information of the subjects correspondingly. For example, the test information may be represented as original scores of the subjects. The planning method for learning 200 can be performed by the processor 130 to multiply the weighting parameters and the original scores of the subjects to obtain the weighting scores. After the planning method for learning 200 performs the fuzzy process to the weighting scores via the processor 130, each of the weighting scores can be transformed into the score level correspondingly. In other words, the planning method for learning 200 can reduce operation complexity of the planning system for learning 100 through the fuzzy process so as to accelerate the operation of the planning system for learning 100.

A description is provided with reference to step S220. In one embodiment, the planning method for learning 200 can be performed by the processor 130 to calculate the weighting parameters of the subjects according to the number of times of learning and learning time of the learning information. In another embodiment, the learning information may be represented as the user's operation information corresponding to the teaching materials for the subjects. For example, the operation information of the teaching materials may be represented as the number of times that the teaching materials are operated or operating time of the teaching materials, and the planning method for learning 200 can be performed by the processor 130 to calculate the weighting parameters of the subjects according to the number of times that the teaching materials are operated and the operating time of the teaching materials. In the present embodiment, the number of times that the teaching materials are operated is positively correlated with familiarity of the user with the teaching materials, and the operating time of the teaching materials is negatively correlated with the familiarity of the user with the teaching materials. Hence, the planning method for learning 200 can be performed by the processor 130 to increase the weighting parameters according to the number of times that the teaching materials are operated and conversion functions correspondingly, or decrease the weighting parameters according to the operating time of the teaching materials and conversion functions correspondingly. It should be understood that the above embodiment only serves as an example for illustrating how the learning information is presented and how the weighting parameters are calculated, and the present disclosure is not limited in this regard.

A description is provided with reference to step S230. In one embodiment, when the weighting score corresponding to a first subject of the subjects is lower than or equal to a first threshold value, the weighting score corresponding to the first subject is transformed into a first score level via the processor 130; when the weighting score corresponding to a second subject of the subjects is higher than the first threshold value, the weighting score corresponding to the second subject is transformed into a second score level via the processor 130. For example, the planning method for learning 200 can be performed by the processor 130 to perform the fuzzy process to the weighting scores to which the different subjects correspond (in the present embodiment, transform them into the first score level or the second score level) by using a predetermined threshold value (in the present embodiment, the first threshold value) so as to reduce the operation complexity of the planning system of learning 100. It should be understood that the above embodiment only serves as an example for illustrating the feasible implementation method of the fuzzy process, and the present disclosure is not limited in this regard. For example, the planning method for learning 200 can be performed by the processor 130 to transform the weighting score of each of the subjects into the score level correspondingly (such as the first score level, the second score level, or a third score level) according to a plurality of predetermined threshold values (such as the first threshold value and a second threshold value).

A description is provided with reference to step S230. In another embodiment, after the processor 130 transforms the weighting score corresponding to the first subject into the first score level, and transforms the weighting score corresponding to the second subject into the second score level, the processor 130 establishes a forward learning sequence from the second subject to the first subject. A description is provided with reference to FIG. 1B and FIG. 1C. For example, when a score level corresponding to a subject A is higher than a score level corresponding to a subject C, the planning method for learning 200 can be performed by the processor 130 to establish a forward learning sequence from the subject A to the subject C. Hence, the planning method for learning 200 can be used to determine that a learning order of the subject A should be superior to that of the subject C for the user, and perform the learning plan for the user. In still another embodiment, when the score level of the subject is higher than the threshold level, the planning method for learning 200 can be performed by processor 130 to determine that the user has the capability to handle this subject so as to suggest the user study some other subject(s) first.

In one embodiment, the planning method for learning 200 can be performed by the monitor 120 to immediately update the learning information of the subjects, and store the updated learning information in the storage 110. In another embodiment, the planning method for learning 200 can be performed by the processor 130 to re-establish the learning plan according to the updated learning information and the updated learning sequence. Since the feasible implementation method for re-establishing the learning plan is described in detail in the above embodiments and shown in FIG. 1B and FIG. 1C, a description in this regard is not provided.

In the above embodiments, the planning method for learning and planning system for learning according to the present disclosure calculate the weighing parameters and the weighting scores according to the learning information, and perform a fuzzy process to transform the weighting scores into the score levels of the subjects so as to establish the learning sequence of the subjects to establish the learning plan via the processor. The learning information may be the user's operation information corresponding to the teaching materials for the subjects and the user's test information of the subjects. Therefore, the planning method for learning and planning system for learning according to the present disclosure can provide the adaptive learning planning services for different users according to the learning information so as to improve the quality of user experience of the planning system for learning and reduce the operation complexity of the planning system for learning through the fuzzy process.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of the disclosure provided they fall within the scope of the following claims and their equivalents.

What is claimed is:

1. A planning method for learning applied to a planning system for learning, wherein the planning system for learning comprises a storage, a monitor, and a processor, and the planning method for learning comprises:
recording learning information of a plurality of subjects and storing the learning information in the storage via the monitor;
calculating weighting parameters of the subjects according to the learning information and calculating weighting scores of the subjects according to the weighting parameters via the processor; and
performing a fuzzy process to the weighing scores via the processor to transform the weighting scores into score levels of the subjects so as to establish a learning sequence among the subjects to establish a learning plan.

2. The planning method for learning of claim 1, wherein calculating the weighting parameters of the subjects according to the learning information via the processor comprises:
calculating the weighting parameters according to the number of times of learning and learning time of the learning information via the processor.

3. The planning method for learning of claim 1, wherein performing the fuzzy process to the weighing scores via the processor to transform the weighting scores into the score levels of the subjects so as to establish the learning sequence among the subjects to establish the learning plan comprises:
transforming the weighting score corresponding to a first subject into a first score level via the processor when the weighting score corresponding to the first subject of the subjects is lower than or equal to a first threshold value; and
transforming the weighting score corresponding to a second subject into a second score level via the processor when the weighting score corresponding to the second subject of the subjects is higher than the first threshold value.

4. The planning method for learning of claim 3, wherein performing the fuzzy process to the weighing scores via the processor to transform the weighting scores into the score levels of the subjects so as to establish the learning sequence among the subjects to establish the learning plan comprises:
establishing a forward learning sequence from the second subject to the first subject via the processor after the processor transforming the weighting score corresponding to the first subject into the first score level and transforming the weighting score corresponding to the second subject into the second score level.

5. The planning method for learning of claim 1, further comprising:
updating the learning information of the subjects immediately and storing the updated learning information in the storage via the monitor; and
re-establishing the learning plan according to the updated learning information and the updated learning sequence via the processor.

6. A planning system for learning comprising:
a storage;
a monitor, configured to record learning information of a plurality of subjects and store the learning information in the storage; and
a processor, configured to calculate weighting parameters of the subjects according to the learning information and calculate weighting scores of the subjects according to the weighting parameters, wherein the processor performs a fuzzy process to the weighing scores to transform the weighting scores into score levels of the subjects so as to establish a learning sequence of the subjects to establish a learning plan.

7. The planning system for learning of claim 6, wherein the learning information of the subjects comprises the number of times of learning and learning time of the learning information, and the processor is configured to calculate the weighting parameters according to the number of times of learning and the learning time of the learning information.

8. The planning system for learning of claim 6, wherein when the weighting score corresponding to a first subject of the subjects is lower than or equal to a first threshold value, the processor transforms the weighting score corresponding to the first subject into a first score level; when the weighting score corresponding to a second subject of the subjects is higher than the first threshold value, the processor transforms the weighting score corresponding to the second subject into a second score level.

9. The planning system for learning of claim 8, wherein after the processor transforms the weighting score corresponding to the first subject into the first score level and convers the weighting score corresponding to the second subject into the second score level, the processor establishes a forward learning sequence from the second subject to the first subject.

10. The planning system for learning of claim 6, wherein the monitor is configured to immediately update the learning information of the subjects, and store the updated learning information in the storage, and the processor re-establishes the learning according to the updated learning information and the updated learning sequence.
